(19) United States
(12) Patent Application Publication
(10) Pub. No.: US 2011/0058717 A1
(43) Pub. Date: Mar. 10, 2011

(54) METHODS AND SYSTEMS FOR ANALYZING HARD TISSUES

(76) Inventors: John Michael Dunavent, Loveland, OH (US); Roger David Gibb, Mason, OH (US); Michael Eugene Rubush, West Chester, OH (US); Matthew Loyd Barker, Mason, OH (US)

(21) Appl. No.: 12/812,954

(22) PCT Filed: Jan. 18, 2008
(86) PCT No.: PCT/US08/51463

§ 371 Date: Jul. 15, 2010

(51) Int. Cl. G06K 9/00

(52) U.S. Cl. 382/128

(57) ABSTRACT

A method and system employing image analysis may provide an objective measure of property values related to hard tissue or teeth in the oral cavity. A region of analysis on an image of hard tissue may be divided into pixels. Each pixel may have an associated color characteristic (e.g., R, G and B, multispectral) which is used to quantify a hard tissue property value of interest (e.g., percent plaque coverage, L*a*b* tooth color, percent stain). Hard Tissues Regions of Interest may be divided into indexed registration cells that allow for combining and/or comparing property values between images on a localized cell-by-cell basis. Results of cell-level property value analyses may be displayed by color-coding hard tissue pixels of a display image.

This patent relates to methods and systems for analyzing hard tissues of an oral cavity.

Imaging systems for analyzing hard tissues, such as teeth, are known in the art. An example is described in U.S. Patent Application Serial No. 2003/0059381, “Structures and compositions increasing the stability of peroxide actives” to Goodhart, et al. However, there is a continuing desire to provide more objective systems and methods for analyzing oral cavity hard tissue condition or health. Further, there is a continuing desire to provide systems and methods for semi-automated or automated analysis of hard tissue, wherein the systems and methods can be used to compare the hard tissues of one or more subjects or to analyze the effect upon hard tissues of one or more products or regimens.

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

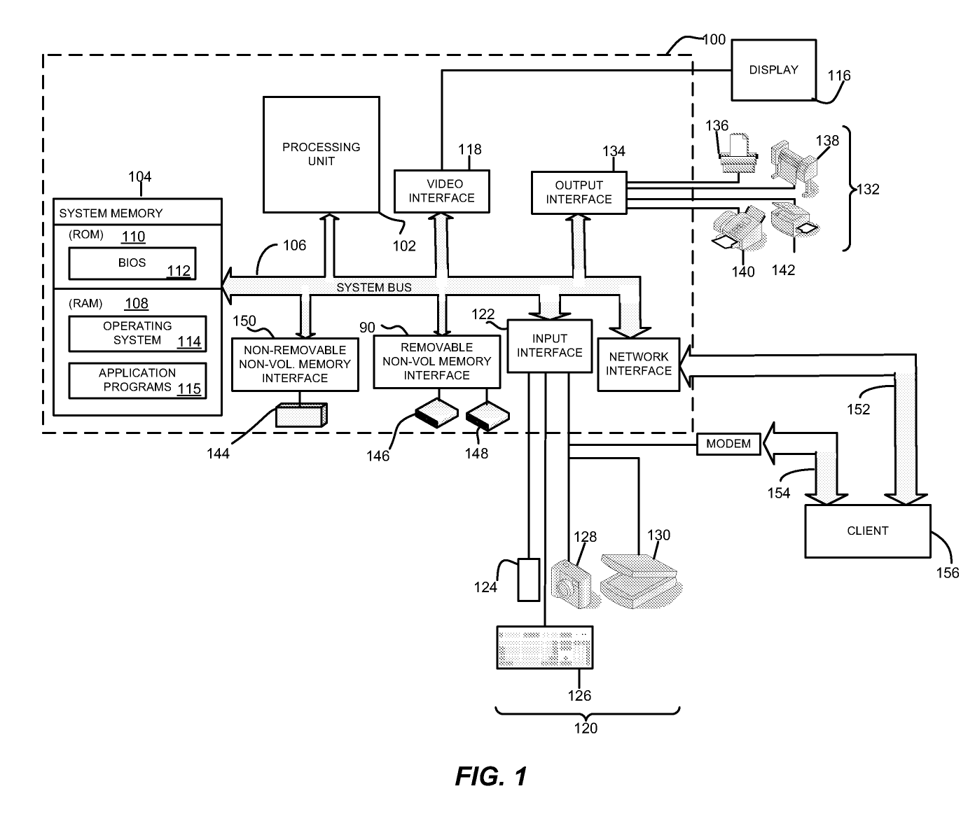

FIG. 1 is a schematic representation of an exemplary general purpose computer for use with a hard tissue analysis method and system according to one or more embodiments of the present invention;

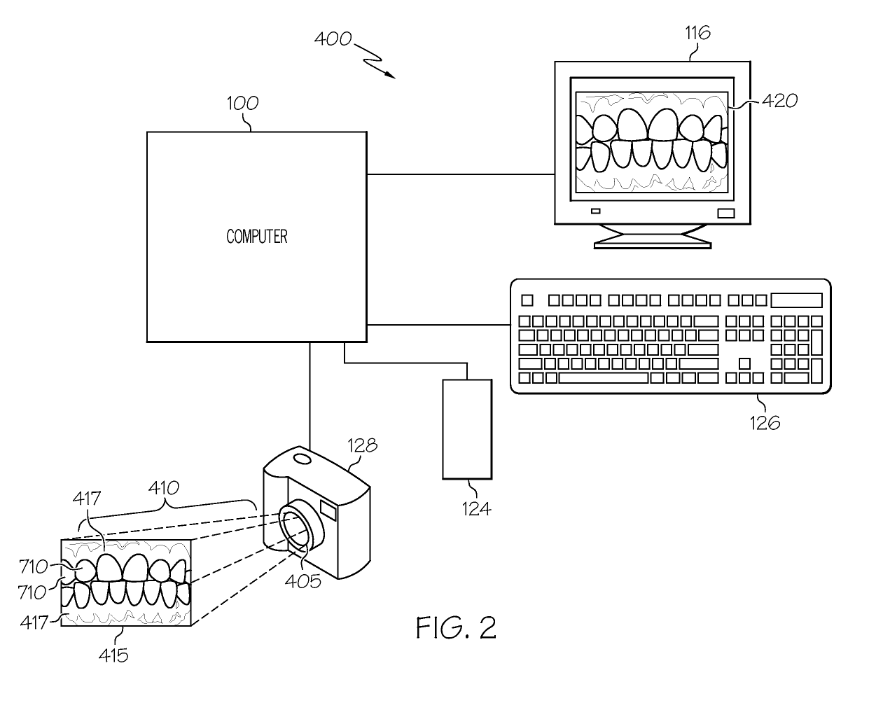

FIG. 2 is a schematic representation of an exemplary hard tissue analysis system according to one or more embodiments of the present invention;

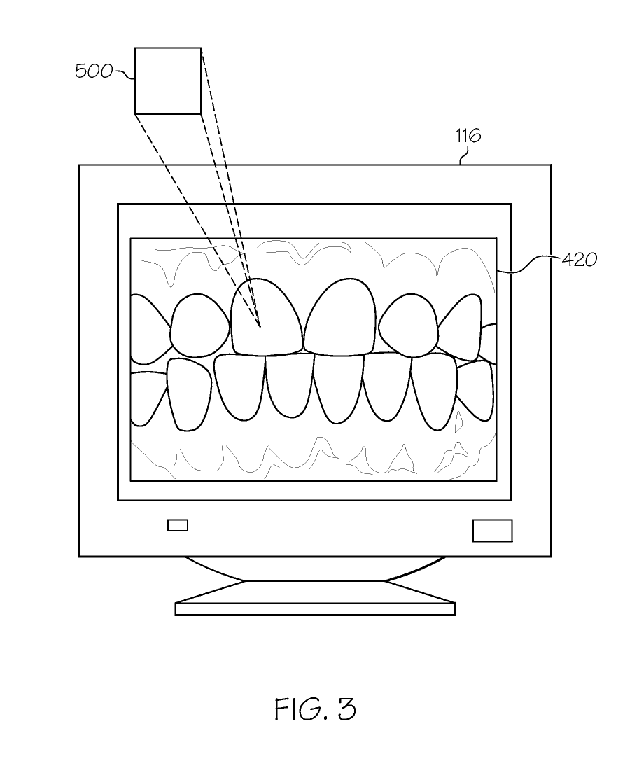

FIG. 3 is a front view of an exemplary hard tissue image and display of the hard tissue analysis system of FIG. 2 according to one or more embodiments of the present invention;

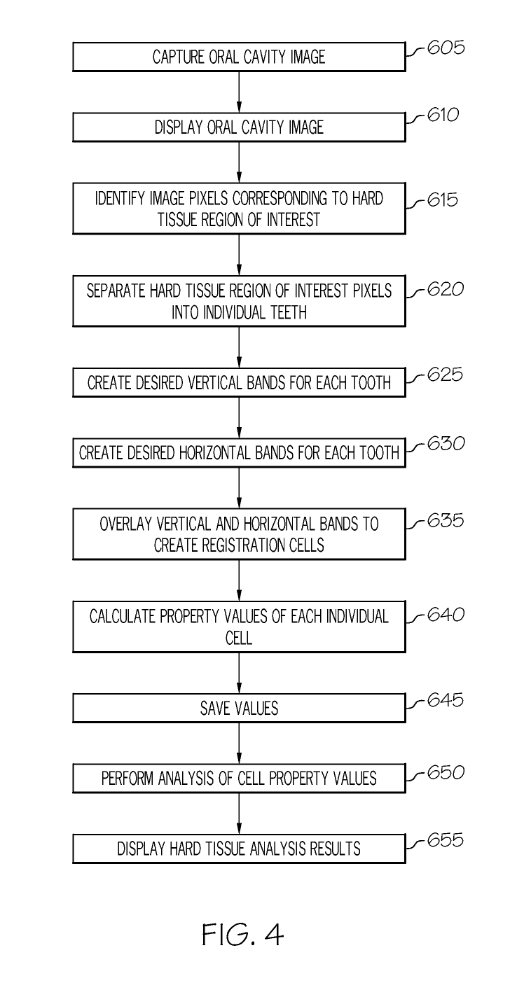

FIG. 4 is a flowchart describing an exemplary method of using the hard tissue analysis system of FIG. 2 to analyze hard tissues according to one or more embodiments of the present invention;

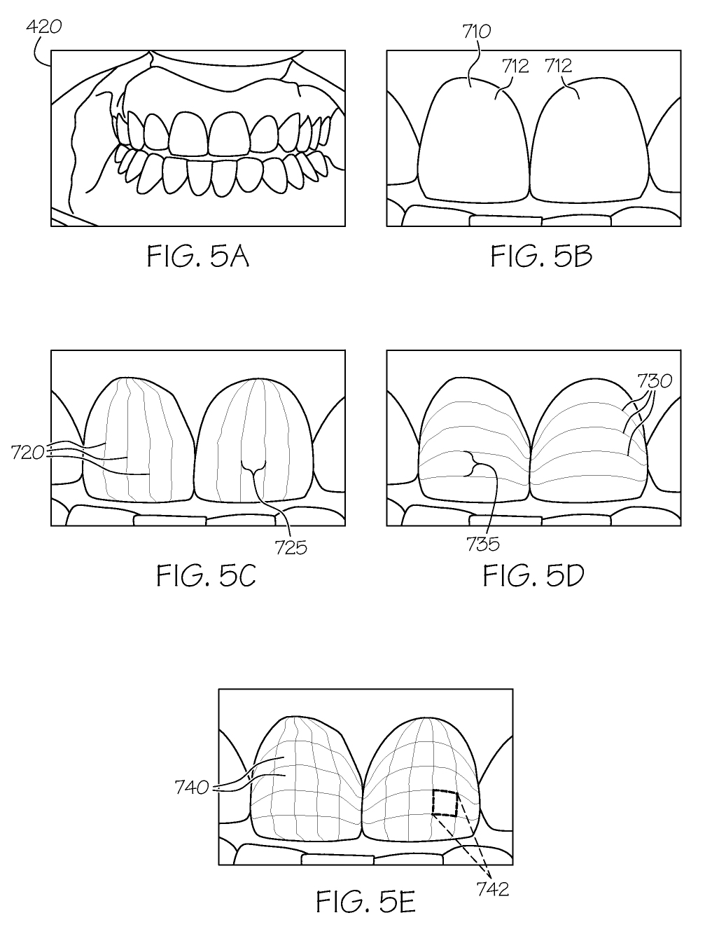

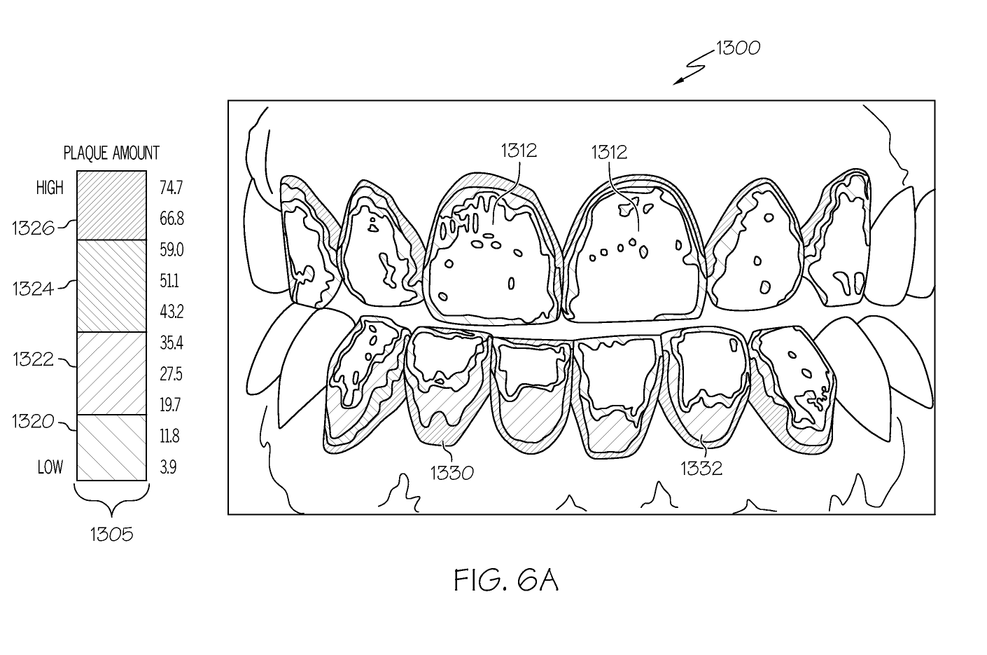

FIG. 5a is an image of an exemplary hard tissue image according to one or more embodiments of the present invention;

FIG. 5b is an image of an exemplary hard tissue image with two teeth of interest selected according to one or more embodiments of the present invention;

FIG. 5c is an image of an exemplary hard tissue image of FIG. 5b with vertical bands according to one or more embodiments of the present invention;

FIG. 5d is an image of an exemplary hard tissue image of FIG. 5b with horizontal bands according to one or more embodiments of the present invention;

FIG. 5e is an image of an exemplary hard tissue image of FIG. 5b with registration cells constructed from the vertical and horizontal bands according to one or more embodiments of the present invention;

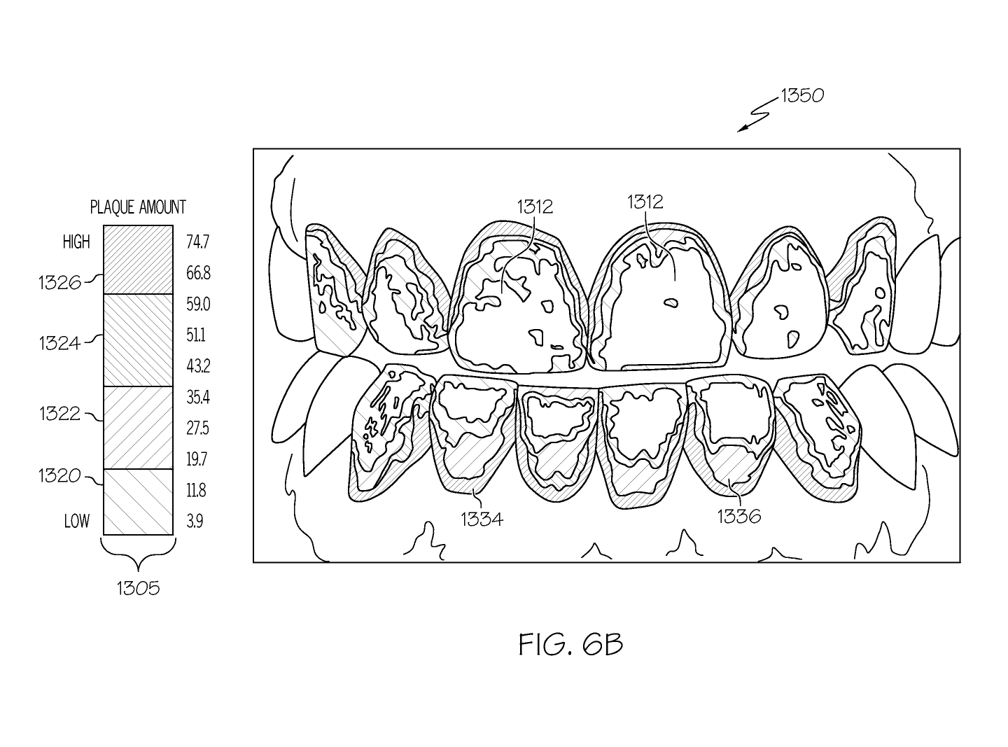

FIG. 6a is an image of an exemplary hard tissue image to which the image analysis methods are applicable according to one or more embodiments of the present invention;

FIG. 6b is an image of an exemplary hard tissue image to which the image analysis methods are applicable according to one or more embodiments of the present invention;

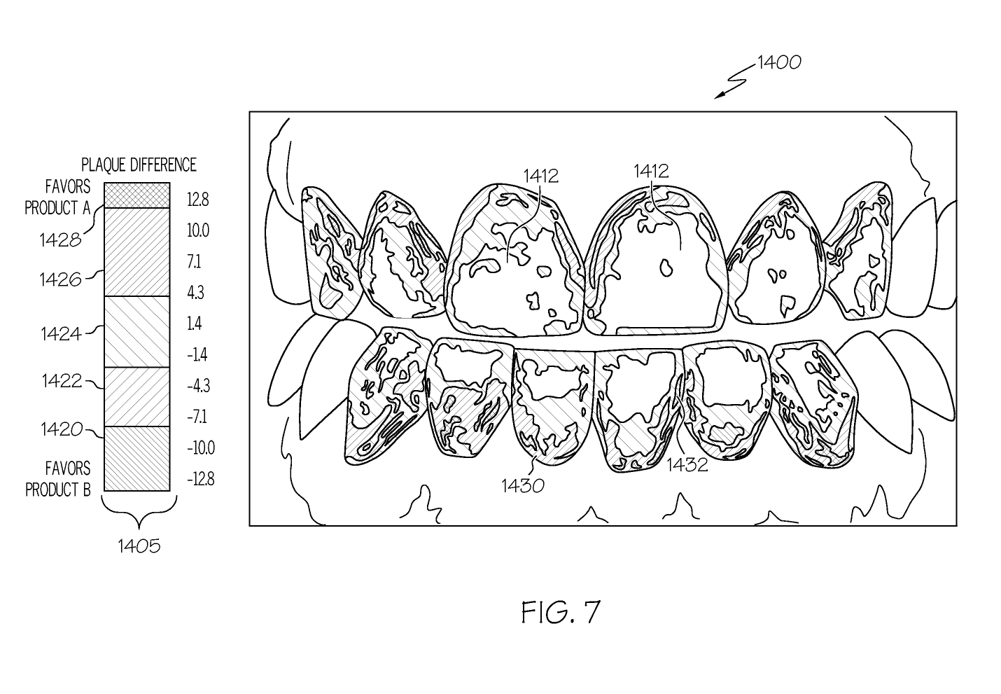

FIG. 7 is an image of an exemplary hard tissue image having a displayed result of hard tissue analysis according to one or more embodiments of the present invention;

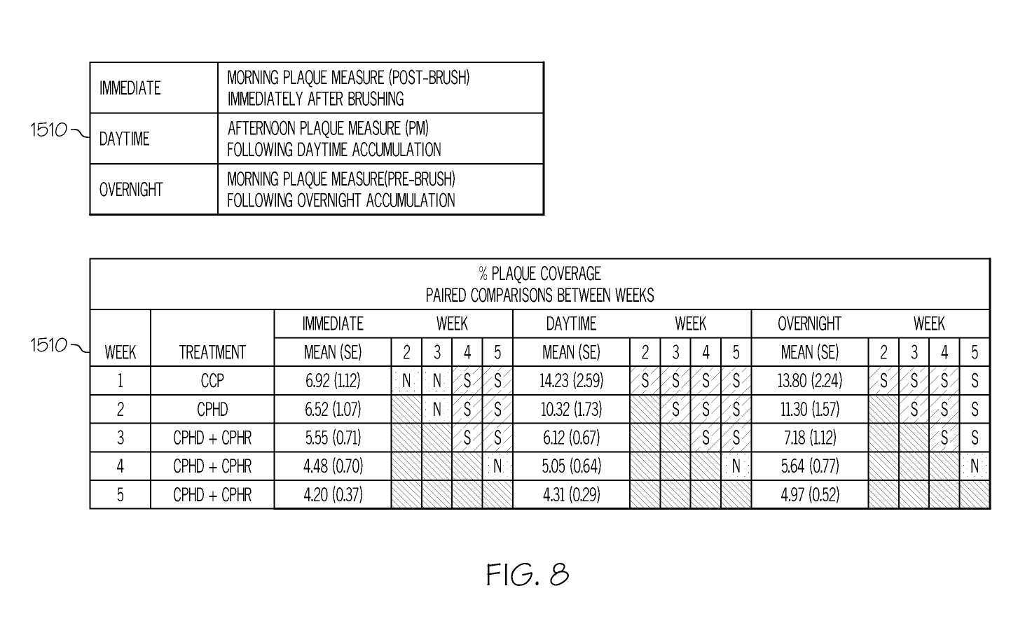

FIG. 8 is a table showing an exemplary tabular displayed result of hard tissue analysis according to one or more embodiments of the present invention;

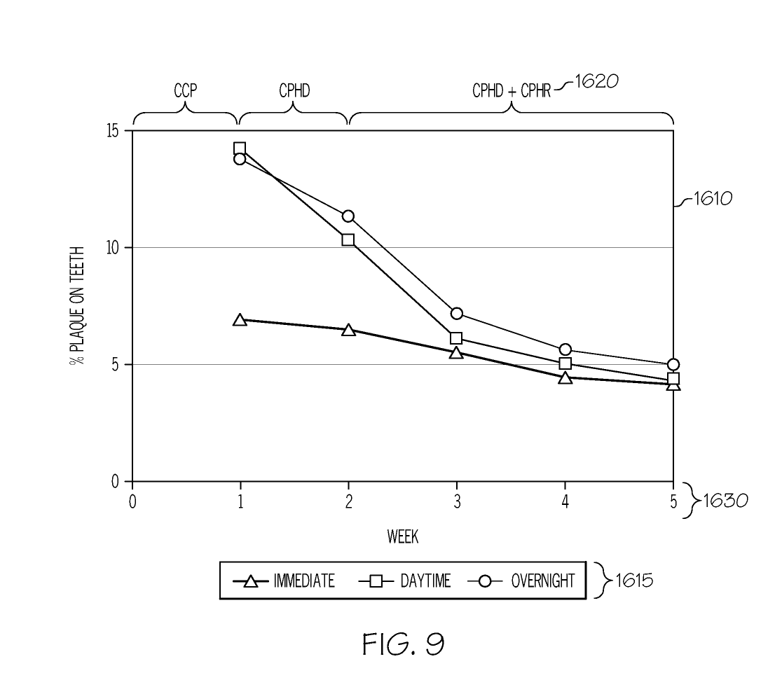

FIG. 9 is a graph of an exemplary graphical displayed result of hard tissue analysis according to one or more embodiments of the present invention; and

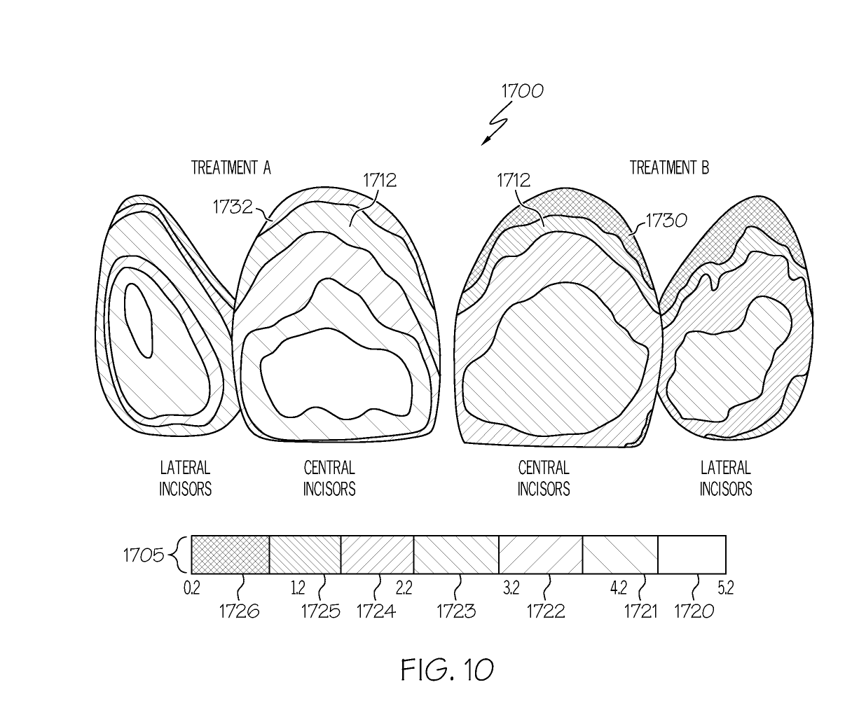

FIG. 10 is an image of an exemplary hard tissue image to which the image analysis methods are applicable according to one or more embodiments of the present invention.

There are broadly described herein methods and systems for analyzing hard tissues. A system and method employing image analysis may provide an objective measure of the state or condition of hard tissue. As used herein, hard tissue may be one or more teeth comprised of dental enamel, any naturally hard structure found in the jaws and used for chewing, or any man-made material representing a tooth such as, but not limited to, crowns, caps, veneers, dentures, partial dentures, dental implants, bridges, and any combinations thereof. For simplicity of discussion, dental enamel will be discussed hereafter as an example of hard tissue suitable for use with the present invention as set forth above. A region of interest on an image of an oral cavity may be divided into pixels, wherein property values of the pixels may be analyzed. A property value may include, for example, a color value or values, coordinate information, plaque present value, plaque not present value, L* value, a* value, b* value, etc. For example, each pixel may have an associated color that may be characterized by one or more color values. As used herein, the term “color value” is intended to refer to one or more numeric values that represent a spectral or other color or pixel characteristic. The characteristic associated with the color value is generically referred to as a color characteristic. Examples of color characteristics include components of a color space (e.g., RGB color space, CIELAB color space, and LCH color space), brightness, luminance, hue, saturation, chroma, color temperature, contrast, intensity, lightness, and reflectance. The color value can include, but is not limited to, a single value, a range of values, multiple values, a statistical value, or any value mathematically calculated from several values or from an algorithm. For instance, a gradient or slope derived from several values or a summation of several values can also constitute a color value. In one embodiment, a user may obtain an objective measurement of oral cavity hard tissue appearance or health (and other conditions) by determining an objective measurement of one or more component color values of a hard tissue image and performing statistical analysis on the color values. Other uses for the present invention may include, but are not limited to, determining the relative efficacy of an anti-plaque product, drug, treatment or regimen by analyzing the hard tissue for changes in color which might indicate reduction of or removal of plaque as a result of the product, drug, treatment or regimen. A regimen may be defined as a method of use for a particular product. A treatment is the use or application of a product according to a predetermined regimen. In another embodiment, specific hard tissue regions of interest may be analyzed. For instance, interproximal dental enamel may be a region of interest, particularly where changes in plaque coverage (or colorimetric changes) may be useful for determining the effectiveness of particular products or regimens with respect to the interproximal dental enamel. In yet another use, the extrinsic or intrinsic whitening efficacy of products, drugs, treatments or regimens, such as hydrogen peroxide bleaches, can be evaluated based upon changes in color.

In one embodiment, the computer-implemented systems and methods automatically analyze hard tissues and/or display the results of this analysis. In another embodiment, a computer system semi-automatically analyzes hard tissues and a human user provides some of the analysis and/or inputs to the computer system and/or displays the results of this analysis. While the invention will be described hereafter with respect to automatic and semi-automatic systems and methods, it is contemplated that the invention encompasses systems and methods for manually analyzing hard tissues, wherein a human user conducts the analysis.

Referring to FIG. 1, a computer system 100 may include a controller or a processing unit (CPU) 102, for example, an Intel Pentium™ class microprocessor. One or more memory devices 104 may be connected to a bus 106, including random access memory (RAM) 108 and read only memory (ROM) 110. A basic input/output system (BIOS) 112, containing the routines that may transfer information between elements within the computer 100, is typically stored in ROM 110. RAM 108 typically contains immediately accessible program modules such as the operating system 114 or application programs 115 currently used by the CPU 102. A display 116 may be connected to the system bus 106 through a video interface 118. Input devices 120 may be connected to the system bus 106 through an input interface 122. Input devices may include a mouse 124, a keyboard 126, a camera 128, a scanner 130 and/or other image capture device. Output devices 132 may be connected to the system bus 106 through an output interface 134 and may include a printer 136, a plotter 138, a facsimile device 140, a photocopier 142, and/or other devices. Input and output devices 120 and 132 may be connected to computer system 100 via hardwire or wireless communications and/or connections.

The computer system 100 may include a computer-readable medium having a computer program or computer system 100 software accessible therefrom. The computer program may include executable instructions for performing methods. The computer-readable medium may be stored on a non-removable, non-volatile memory device 144 such as a hard disk or data store, or a removable, non-volatile memory device such as a floppy disk drive 146 or an optical disk drive 148. The non-removable, non-volatile memory device 144 may communicate with the computer 100 system bus 106 through a non-removable, non-volatile memory interface 150. The computer-readable medium may include a magnetic storage medium (disk medium, tape storage medium, microdrives, compact flash cards), an optical storage medium (compact disks such as CD-ROM, CD-RW, and DVD), a non-volatile memory storage medium, a volatile memory storage medium, and data transmission or communications medium including packets of electronic data, and electromagnetic or fiber optic waves modulated in accordance with instructions. Thus, the computer readable medium tangibly embodies a program, functions, and/or instructions that are executable by the computer system 100 to perform methods as described herein.

The computer system 100 may be connected to a network, including local area networks (LANs) 152, wide area networks (WANs) 154, portions of the Internet such as a private Internet, a secure Internet, a value-added network, or a virtual private network. Suitable network clients 156 may include personal computers, laptops, workstations, disconnectable mobile computers, mainframes, information appliances, personal digital assistants, and other handheld and/or embedded processing systems. The signal lines that support communications links to clients 156 may include twisted pair, coaxial, or optical fiber cables, telephone lines, satellites, microwave relays, modulated AC power lines, and other data transmission “wires” known to those of skill in the art. Further, signals may be transferred wirelessly through a wireless network or wireless LAN (WLAN) using any suitable wireless transmission protocol, such as the IEEE series of 802.11 standards. Although particular individual and network computer systems and components are shown, those of skill in the art will appreciate that the present invention also works with a variety of other networks and computers.

With reference to FIG. 1 and FIG. 2, an automated system 400 for analyzing hard tissues such as, for example, hard tissues in the oral cavity, may include a first input device in the form of a digital camera 128, a second input device in the form of a mouse 124, a third input device in the form of a keyboard 126, and a display 116. The digital camera 128 may be connected directly (e.g., hard-wired or wireless connections) to the computer 100 for transferring images thereto or images may be stored on a portable computer readable medium which may be read by a device connected to the computer 100. The digital camera 128 may be configured to have a sensor 405, such as a Bayer Pattern Sensor or 3 CCD sensors such as those found in a 3-chip camera, that has an array of rows and columns of photosensitive detectors (such as a charge-coupled device or CCD) for detecting light 410 from an image, e.g., captured image 415. The captured image 415 may be single-spectra (grayscale) or multi-spectral (e.g., RGB). A processor within the digital camera 128 converts the output from the sensor 405 into a data file that records one or more color values associated with each photosensitive detector. The color value may typically be a luminance value for one or more of R, G, and B values. The values may range between 0 and 255 for an 8-bit camera. A higher bit depth camera may be used, in which case the values may have a much greater range (e.g., a 12-bit camera has a range of 0 to 4,095).

With reference to FIG. 1, FIG. 2, and FIG. 3, the display device 116 may display captured images 415 as any number of picture elements, or pixels (e.g., pixel 500). A pixel 500 of the display device 116 of the system 400 may display a color based upon the R, G, and B color values recorded from the digital camera 128, to reproduce the captured image 415 as a displayed image 420 on the display 116. Display 116 may be a monitor, display panel, kiosk, TV, projection screen, or any other known display device. Displayed image 420 may be an exact reproduction of captured image 415 or an image of captured image 415 that has been processed by system 400. For example, the system 400 may process the captured image 415 by focusing on a Hard Tissue Region of Interest (HTROI) within the captured image 415. For example, the camera 128 may record and the computer 100 may display values of 188 for R, 154 for G and 132 for B for the pixel 500. The color values can be stored in a variety of digital file formats, including Joint Photography Experts Group standard (JPEG) and Tagged Image File Format (TIFF). Other file formats may be used as known in the art. The position of the pixel 500 within the displayed image 420 and the display 116 may also be recorded on the computer system 400. The position of the pixel 500 may be expressed as a set of coordinates, x and y, for example, where “x” may represent the pixel 500 position along a horizontal axis and “y” may represent the pixel 500 position along a vertical axis. The pixel's 500 RGB values and position may be stored on the system 400. While a digital camera is illustrated, it may be appreciated that an analog camera may be used with the system 400 to record images on film. The film images may then be scanned by a scanner 130 connected to the computer 100 and the images recorded on a computer readable medium connected to the system 400.

Referring to FIG. 1, FIG. 2, FIG. 3, FIG. 4, and FIG. 5, a method, which may be computer implemented, is illustrated. The method may comprise a plurality of operations for analyzing a hard tissue image and displaying the analysis results. The method may include any combination of the several operations as herein described. At step 605, a camera 128 may create or capture a captured image 415 of a subject's oral cavity, and the captured image 415 may be recorded on the system 400. The captured image 415 may comprise hard tissues and/or soft tissues, including, but not limited to one or more teeth 710 and/or one or more gum regions 417. The hard tissues may include, but are not limited to, maxillary and/or mandibular arches, for facial, lingual, and occlusal surfaces. Instruments, such as retractors, may be employed to expose the desired portion of the hard tissue for an image capture and analysis.

The captured image 415 may be obtained with a digital camera 128 under controlled lighting conditions. An example of a digital camera 128 may be the JVC KY-F75U Digital camera as produced by the JVC of Tokyo, Japan. The camera 128 may be of suitable resolution for capturing color gradations, particularly the color variances in hard tissues. For example, a digital resolution of 800×600 pixels or greater may be suitable. Further, the digital camera 128 may be able to obtain captured images 415 in a selected one of the R, G, or B color wavelengths, or may be a multi-spectral camera. The camera 128 may also be configured with a linear polarizing lens that may capture cross-polarized light, or any other lens that may reduce the amount of glare or other light interference received at the camera 128. An example of a suitable lens may be the 25 mm Linos MeVis-C lens with a linear polarizer produced by Linos Corporation of Germany A standard, fixed set-up may be used to ensure reproducible conditions with respect to light—subject—camera geometry. A digital camera 128 may be mounted a fixed distance away from a cup-type chin rest with lights positioned on each side of the camera 128. The body of the camera may be a distance from the front of the chin rest. Dedo™ lights of the type produced by Dedotec, USA, Inc. of Cedar Grove, N.J. may be mounted on each side of the camera 128 and equipped with a series of filters. Each light may be positioned a distance from the system centerline. The lights may also be placed at an angle relative to the centerline of the system. The light filters may be a heat shield, a polarizer, and a bluing filter. The heat shield may serve as a comfort measure for the subjects, the polarizer may provide polarized light to the tooth surfaces, and the bluing filter may raise color temperature. The filters may be attached to the front of the lights using a custom mounting bracket that positions the filters a distance from the front of the light lens. Each Dedo™ light may be fitted with a suitable bulb, for example, the Xenophot™ type, 150W, 24V as produced by Sylvania of Danvers, Mass. The bulb may be powered with a tunable voltage power supply and powered in series. The slideable bulb socket of the Dedo™ light may be positioned at the back of the light housing and locked down. A power supply equipped with a rheostat may be used to set the voltage to approximately 46V. A difference between the series bulb voltage and initial set-point may protect against accidental overpowering of the bulbs and may provide adjustment latitude during calibration and standardization. The camera 128 may obtain a captured image 415 in a setting configured to eliminate any extraneous light from windows or other light sources. For example, the only light in the room may be provided by the imaging system light sources. The system may be placed a distance away from camera-visible walls, such that, the camera may not detect light reflected off of the walls.

A zoom lens may be attached to the camera 128 for better imaging. The lens may be a Fujinon S16x7.3DA-DSD type lens as produced by Fujinon Corp. of Saitama, Japan. The focal plane of the lens may be set a distance from the lens and the lens may be locked down to prevent adjustments. A polarizer may be added to the zoom lens and rotated to a position of cross polarization relative to the light polarizer. The cross polarization may be set by placing a chrome ball or other reflecting surface at the focal plane and rotating the polarizer on the lens until the glare spots on the reflecting surface disappear. A suitably-sized chrome ball may be approximately 19 mm in diameter. This combination of lighting, camera and lens settings may produce RGB values of approximately equal and not saturated for a pure white sample, to assure that the camera may not be saturated on any of the color channels.

The height of the chin rest may be mounted such that the floor of the chin rest may be a distance from a support surface. Other fixation may be used, such as a forehead rest. Images may be captured without any fixation. Similarly, the bottom of the camera base may be a distance from the support surface. The camera 128 may be controlled by a general purpose computer 100. One example of a general purpose computer may be produced by Dell, Inc. of Round Rock, Tex.

While in use, the system 400 may be black/white balanced and standardized to one or more color reference standards. The black balance may be established by putting the lens cover on and capturing an image 415. The black balance may be adjusted until uniformity is achieved across the R, G and B channel A gray reference standard image in the focal plane may then be captured and the white balance adjusted to bring the color channel values to uniformity across R, G and B channels. After white balancing, a second image of the gray standard may be captured. The gray value of each pixel may be normalized to the mean intensity of the image to generate a position dependant ratio correction for any variations in lighting intensity across the field of view of the camera. This intensity correction may be applied to each subsequently captured image.

An image of a color standard may be captured as a separate image or as part of an image of the oral cavity. The average R, G and B values of each color may be extracted and compared to a standard set of values which serve as the standardization point for the camera 128. These standardization values may be determined by using several cameras to capture images under the conditions established with the system 400. If the R, G and B values are within pre-established tolerance values, then no further system 400 adjustment may be needed. If the values are outside tolerances, the system 400 may be adjusted. For example, the light intensity may be adjusted to bring the system 400 within the tolerances.

To color correct for inevitable remaining differences between the captured values and the standard values, a polynomial color correction may be established by regressing the standard values for each channel against the captured values including the cross channel terms where:

Rcorrected=f1(Rinput, Ginput, Binput);

Gcorrected=f2(Rinput, Ginput, Binput); and

Bcorrected=f3(Rinput, Ginput, Binput).

The system 400 may be color calibrated approximately every hour during use or more frequently as needed. After successful standardization, the position dependent intensity correction and the color correction may be applied to each subsequently captured image until the next calibration cycle. If a color standard is captured in each image, standardization may be performed separately for each image. Each calibration set including raw values and calibration results may be written to a text file each time the system is calibrated. A complete system 400 calibration to include, but not limited to, light standardization, light-camera-subject geometry, polarization calibration, black/white balance, and color standardization may be performed before daily use.

A subject may use cheek retractors such as those supplied by Salvin Dental Specialties of Charlotte, N.C. to pull the cheeks back and allow for unobstructed illumination of the hard tissues. Prior to use, the clear retractors may be given a matte finish to avoid the possibility of depolarizing the light and producing glare in the captured image 415. Each subject may then put his or her chin in the rest, while the operator provides instructions to properly align the subject based on a live output view from the camera 128. Each subject may hold the maxillary and mandibular incisors tip to tip to avoid an overlap of the maxillary and mandibular teeth. The subjects may be instructed to look straight into the camera 128 to avoid any left right rotation and forward or backward tilting of the head, and to pull retractors by the ends of the handles toward the ears to avoid any shadowing resulting from the retractors or the subject's hands. Retractors may also be of a one-piece design that may expose the desired area of hard tissue automatically without the subject's involvement. The subject may also retract the tongue away from the teeth. If excess saliva is observed, the subject may remove the retractors, and close his or her mouth to clear the saliva before repositioning. When in position, the image 415 may be captured, processed through the intensity and color correction, and saved to the system 400.

Referring to FIG. 4 and FIG. 5a, at step 610, the captured image 415 from step 605 may be transferred to and displayed on the display 116 as a hard tissue image 420 of the system 400 as shown, for example, in FIG. 2 and FIG. 3. At step 615, the image pixels corresponding to the teeth of interest may be identified. At step 620, pixels of the teeth may be separated into individual teeth. As will be described below, registration cells that define a tooth map may be created that aid in locating the same relative location on teeth of different subjects and/or in different images or pictures and of the same subjects across different images or pictures. Thus, a property value or cell value of a registration cell may be located, compared, and/or calculated for the same relative location on hard tissue of different subjects and/or in different images or pictures and of the same subjects across different images or pictures.

With reference to FIG. 5b, at step 615, the pixels that identify hard tissue may be selected for analysis. A masking procedure may be utilized to identify a HTROI within the captured hard tissue image 415. The HTROI 712 to be analyzed may comprise pixels representing a tooth, a plurality of teeth or a part of a tooth, for example. The HTROI 712 may be identified automatically by a computer algorithm, such as one developed using Statistical Analysis System (SAS) as produced by SAS Institute Inc. of Cary, N.C., for example. The automated computer algorithm may also utilize, but not be limited to, a quadratic discriminant classification function as a basis for identifying HTROI pixels. The methods of identifying the HTROI pixels in the examples provided herein are not watershed algorithms. The coordinates outlining the HTROI pixels may also be manually selected using a mouse 124, any suitable pointing device, or the keyboard 126. A suitable and readily-available computer application such as the ImageJ (National Institutes of Health, USA) freeware application may be used to identify the HTROI pixels. Both automated and manual pixel selection methods may be used in combination.

Other information may also be collected and saved with the data representing the tooth pixel coordinates such as a time or type of visit prompting the analysis, an indication of whether the data represents an analysis of the mandibular or maxillary arch, and an indication of the physical location (e.g., X-Y coordinates) of the pixel in the displayed image 420. Also, any range of teeth from any region of the subject's oral cavity and/or a variety of angles of the oral cavity may be selected for captured image 415 and displayed image 420. Lingual surfaces may also be selected and points chosen.

With reference to FIG. 5b, at step 620, the pixels identified as the HTROI 712 in step 615 may be further separated into individual teeth, e.g., right maxillary central incisor, left mandibular lateral incisor, etc. The process of separating HTROI pixels into individual teeth may be done automatically by a computer algorithm, such as one developed using SAS, for example. Separation of HTROI pixels into individual teeth may involve identification of two or more pixels that lie on the physical boundary separating teeth, followed by mathematical interpolation between these coordinates. A suitable and readily-available computer application such as the ImageJ may be used to identify the pixels that lie on the boundary between teeth. Both automated and manual methods of separating HTROI pixels into individual teeth may be used in combination.

With reference to FIG. 5c, at step 625, the HTROI pixels, image data, and other measurements may be organized or arranged to define a plurality of unique vertical bands 725 for each tooth of interest 710. The vertical bands 725 may begin at a top portion of each tooth of interest 710 and extend to the bottom of each tooth 710. The vertical bands 725 may be separated by boundaries 720. The width of the vertical bands 725 may be dependent upon the number of vertical bands 725 created and the physical dimensions of each tooth. The number of desired vertical bands 725 may vary depending upon user preference, the type of analysis desired, and the resolution of the camera 128 used to capture the displayed image 420. The width of vertical bands 725 may or may not be uniform. For example, the width may be more narrow close to the top area of the tooth 710 than the area in the center of the tooth 710. The width of the vertical bands may be proportional to the width of the tooth 710 at each vertical position of the tooth 710. More specifically, in creating the vertical boundaries 720 that define the vertical bands 725, a horizontal row having a width of one or more pixels may be selected along a tooth 710 or HTROI 712. This horizontal row may then be divided into m number of equal segments, with a pixel indicating the border of each segment. Next, a new horizontal row may then be selected at one or more pixels above or below the last horizontal row, and the process is repeated until the edge of the tooth 710 or HTROI 712 is reached and m number of vertical bands 725 are created. If two or more images are to be compared with respect to analyses dependent on the position of vertical bands 725, the same vertical band construction algorithm should be applied to each image in question.

With reference to FIG. 5d, at step 630, the HTROI pixels, image data, and other measurements may be organized or arranged to define a plurality of unique horizontal bands 735 for each tooth of interest. The horizontal bands 735 may begin on one side edge of the tooth of interest 710 and extend to the other side edge of the tooth. The horizontal bands 735 may be separated by boundaries 730. The height of the horizontal bands 735 may be dependent upon the number of horizontal bands 735 created and the physical dimensions of the tooth 710. The number of desired horizontal bands 735 may vary depending upon user preference, the type of analysis desired, and the resolution of the camera 128 used to capture the displayed image 420. The height of horizontal bands 735 may or may not be uniform. For example, the height 735 may be more narrow close to the side edge of the tooth 710 than the area in the center of the tooth 710. The height of horizontal bands may be proportional to the height of the tooth at each horizontal position of the tooth. For example, similar to creating the vertical boundaries 720, in creating the horizontal boundaries 730 that define the horizontal bands 735, a vertical column having a width of one or more pixels may be selected along the tooth 710 or HTROI 712. This vertical column may then be divided into n number of equal segments, with a pixel indicating the border of each segment. Next, a new vertical column may be selected to the left or the right of the last vertical column and the process is repeated until the edge of the tooth 710 or HTROI 712 is reached and n number of horizontal bands 735 are created. If two or more images are to be compared with respect to analyses dependent on the position of horizontal bands, the same horizontal band construction algorithm should be applied to each image in question.

Referring to FIG. 5e, at step 635, the vertical 725 and horizontal bands 735 may be overlaid to create unique registration cells 740 that are created on a HTROI. As illustrated in FIG. 5e, a registration cell is formed at the intersection of one of the vertical bands 725 and one of the horizontal bands 735. The registration cells 740 may be utilized to create a map of the surface of the individual tooth or teeth 710 within the image 420. The individual registration cells 740 may aid in analyzing similar areas of teeth between different subjects and/or different images 420. For example, an individual or plurality of registration cells 740 of one subject may be compared against the same registration cell or cells 740 of another subject. Similarly, an individual or plurality of registration cells 740 of an earlier image 420 of a tooth or teeth 710 from the subject may be compared with the registration cell or cells 740 of an image 420 of the same tooth or teeth 710 of the same or different subject taken later in time.

The registration cells 740 may have a variety of shapes and sizes. The cells 740 may contain between about 1 and 10,000 pixels or such other number of pixels as technology may allow. The cells 740 may be uniform in shape and/or size or may vary from cell to cell, depending upon the desired analysis. In one embodiment, they may be approximately rectangular and have a length and/or width determined by the width and contour of the tooth, as well as the number of vertical 725 and horizontal bands 735. A computer program written using the SAS software product, for example, may create the vertical bands 725, the horizontal bands 735 and the registration cells 740.

At step 640, property values of the pixels, which may initially consist of a color characteristic and/or value (e.g., RGB value) within each of the registration cells 740 may be mathematically analyzed for patterns and trends that may permit the matching of a diagnosis. A property value may represent any property of an individual pixel depending on the type of desired analysis. For example, a property value might represent the natural color value of the pixel. In the context of plaque analysis, the property value might be a binary value that represents whether or not plaque is present at a particular pixel (i.e., plaque present value, plaque not present value). In teeth whitening applications, the property value may indicate a L*, a*, and b* value.

If testing plaque coverage on a tooth surface 710, for example, a fluorescent dye may be applied to the mouth of the subject, followed by capturing a digital image 415 (step 605) of the mouth. Presence of plaque on a tooth surface 710 may be detected and a calculation of the percentage of plaque may be performed. A plaque “1” value, i.e., a property value, may be applied to a pixel where plaque is present, and a plaque “0” value may be applied to a pixel where plaque is not present. The property values for the pixels within a registration cell 740 averaged or otherwise mathematically calculated are referred to herein as cell values with a unique identifier associated with its hard tissue location. For example, in one exemplary individual registration cell 742, 60% of the pixels within the cell may have plaque present, and therefore the cell value of the particular registration cell 742 would be 60%.

The effectiveness of teeth whitening products may also be analyzed. The R, G, and B values from the image 420 may be converted to L*, a* and b* property values. The L*, a* and b* property values within a registration cell 740 may then be averaged to provide a cell value for that particular registration cell 740. It is contemplated that many other analyses may be performed, including but not limited to extrinsic stain, intrinsic stain, calculus (tartar), erosion, gingival recession, bruxism, decay, fluorosis, tooth separation, fracture, cracking, etching, porosity, or shine.

Alternatively, the property values for the pixels of the entire tooth 710 may be averaged or otherwise mathematically calculated. For instance, the property value for each registration cell 740 may be combined to create a property value for the entire tooth 710 or each registration cell 740 property value may be separated for local analysis. In the context of a plaque analysis, the percentage of pixels containing plaque within a registration cell 740 may be calculated. An example for a registration cell 740 of the tooth 710 containing 10 pixels where the R, G and B values of the pixels within the registration cell 740 have been averaged is set forth below in Table 1.

TABLE 1

| Pixel (x, y) | R Value | G Value | B Value | Plaque Classification |
|---|---|---|---|---|
| (1, 1) | 60 | 160 | 51 | 1 |
| (2, 1) | 75 | 175 | 54 | 1 |
| (3, 1) | 60 | 153 | 59 | 1 |
| (4, 1) | 63 | 159 | 63 | 1 |
| (5, 1) | 53 | 159 | 154 | 0 |
| (6, 1) | 57 | 157 | 146 | 0 |
| (7, 1) | 49 | 155 | 143 | 0 |
| (8, 1) | 45 | 150 | 139 | 0 |
| (9, 1) | 46 | 152 | 149 | 0 |
| (10, 1) | 47 | 152 | 149 | 0 |
| Average | 56 | 157 | 111 | 0.40 |

The average property values for an individual registration cell 742, a plurality of registration cells 740, an entire tooth 710, or any number of teeth may be similarly averaged or mathematically calculated. For example, as shown in FIG. 5e, a registration cell 742 may be selected according to user preference, for example, if the user determines that the cell 742 should be examined more closely. Other registration cells 740 may be selected as a group as related to a particular tooth. The property values for a group of cells 740 may be averaged or otherwise calculated to determine a representative property value for the group of cells 740 or the tooth surface 710 to create a hard tissue analysis result that may be displayed.

At step 645, the cell values and/or property values from step 640 may be saved to a computer-readable medium either on or connected to the system 400 or sent to another computer 100 and stored for archival purposes or further processing. At step 650, the computer 100 may perform several analyses on the data collected to create hard tissue analysis results and saved at step 645. At step 655 the computer 100 may display data, statistics, and/or images related to the analysis of step 650 (e.g., hard tissue analysis results) in a variety of formats, including but not limited to color images (e.g., pictorial), tabular, or graphical. Several different types of analyses may be performed on the data saved at step 645. Each analysis may be performed alone or in combination with other types of analyses.

At step 650, the cell values from two or more images may be combined by averaging or other mathematical calculation on a registration cell-by-cell basis to create additional hard tissue analysis results. Cells values are matched between images using the unique identifier associated with its hard tissue location. For example, the cell values from images for a single subject taken at two visits, once before and once after treatment, could be subtracted to form a change from baseline for each cell. Alternatively, the cell values from subjects (different images for different subjects) on the same treatment could be averaged to form a group average for each cell. In addition, the change from baseline cell differences for a group of subjects may be averaged to form a group average change from baseline for each cell uniquely identified by its hard tissue location. Finally, average cell values for a group of subjects (Product A) and the average cell values for another group of subjects (Product B) could be subtracted on a cell-by-cell basis to form an average product group difference as the hard tissue analysis result. It is contemplated that many other cell combination analyses may be performed as well. An example for a group of subjects with cell values averaged to determine the percentage of plaque coverage for a specific hard tissue cell location (e.g., cell location #3) is set forth below in Table 2.

TABLE 2

| Cell Location #3 | Percent Plaque |
|---|---|
| Image #1 | 0.45 |
| Image #2 | 0.14 |
| Image #3 | 0.02 |
| Image #4 | 0.81 |
| Image #5 | 0.68 |
| Image #6 | 0.78 |
| Average | 0.48 |

The analysis data at step 650 may be displayed or reported in a tabular format (FIG. 8), a graphical format (FIG. 9), or a pictorial format (FIG. 6a, FIG. 6b, FIG. 7, and FIG. 10). The pictorial format illustrated in FIGS. 6A, 6B, 7 and 10 comprise a hard tissue analysis result(s) displayed pictorially on a hard tissue image to create a pictorial displayed result (e.g., images 1300, 1350, 1400, 1700). For example, the pictorial format (e.g., FIGS. 6a, 6b, 7, and 10) may comprise a displayed digital image of an oral cavity (e.g., clinical photograph, captured image 415, the displayed image 420, an image of the HTROI, other image types, or any combination thereof) that includes color-coded hard tissue analysis results superimposed on the image, to form pictorial displayed results. As defined herein, ‘pictorial format’, ‘pictorial displayed results’, ‘displayed pictorially’, ‘displaying pictorially’ or any derivations of the same by the system 400 do not include graphical or tabular displays. The range of analyzed cell values could be mapped to a range of color-coded values (hereafter known as the color legend 1305) to facilitate interpretation of results. Referring to FIGS. 6A and 6B, the color-coded values may be chosen arbitrarily and may or may not correspond to the actual colors in the image.

For a pictorial displayed result image, pixels within each registration cell 740 may be color-coded to match the color legend 1305 and associated cell values at the specific hard tissue locations. Although the shading patterns (e.g., 1320, 1322, 1324, and 1326) of the color legend 1305 appear to represent distinct shades or colors, the color legend 1305 may comprise a gradient scale representing many varying shades of color and/or multiple colors. This also applies to the exemplary color legends 1405 and 1705 of FIGS. 7 and 10, respectively. For example, the lower and lighter portion of color legend 1305 (lighter shade of blue, e.g., 1320 and 1322) may represent less plaque on the HTROI, and the upper and darker portion of the color legend 1305 (darker shade of blue, e.g., 1326) may represent more plaque in the HTROI.

In FIG. 6A, for example, the average percent plaque coverage for a group of subjects (using Product A) is displayed pictorially on a registration cell-by-cell basis at a point in time. For example, the point in time may be in the morning before the subjects brush their teeth. The average percent plaque coverage on the teeth is indicated by the color-coded range of color legend 1305, wherein different levels of plaque may be indicated by various shades of blue, for example. Low plaque levels may be indicated by light blue (as illustrated by cross-hatch pattern 1320) and high plaque levels may be indicated by dark blue (as illustrated by cross-hatch pattern 1326), with many different shades in between. The average percent plaque coverage is matched to each registration cell of the HTROI 1312 in an image to create the pictorial displayed result 1300. As an example, region 1330 is a region of high plaque amount as represented by the color of cross-hatch pattern 1326, which may be dark blue, while region 1332 is a region of lesser plaque amount as represented by the color of cross-hatch pattern 1322, which may be a medium shade of blue.

In FIG. 6B, the average plaque coverage for a group of subjects (using Product B) at a similar point in time (e.g., in the morning before the subjects brush their teeth) is displayed pictorially on an image using similar color-coding to create the displayed results image 1350. Similarly, region 1334 is a region of high plaque amount as indicated by a the color of cross-hatch pattern 1326 (which may be dark blue), while region 1336 is a region of lesser plaque amount as indicated by the color of cross-hatch pattern 1322 (which may be a medium shade of blue), for example.

In one exemplary embodiment, the method of the present invention may include creating the original hard tissue image at a first location and sending the captured image to a second location, wherein analyzing the at least one property value comprises analyzing the at least one property value at the second location. The captured image may be sent using a variety of devices and means, including but not limited to the Internet, a local network, a facsimile, an e-mail, a satellite link, or a postal service.

FIG. 7 shows another exemplary embodiment of a pictorial displayed result using the present invention, wherein the difference in average percent plaque coverage between two groups of subjects, one group using Product A and another using Product B, is displayed pictorially on a registration cell-by-cell basis at a point in time. The difference in average percent plaque coverage between groups is indicated by the color-coded color legend 1405 and matched to each registration cell in the display image 1400. The color legend 1405 may comprise multiple colors. For example, the bottom of color legend 1405 may be dark red (represented by cross-hatch pattern 1420), the middle of color legend 1405 may be yellow (represented by cross-hatch pattern 1424) and the top of color legend 1405 may be green (represented by cross-hatch pattern 1428), with transitional shades of color therebetween. In the exemplary embodiment illustrated in FIG. 7, the region 1430 in the present illustration favors Product A (which may be a shade of green, as indicated by cross-hatch pattern 1426), while the region 1432 favors Product B (which may be a shade of red, as indicated by cross-hatch pattern 1420).

FIG. 10 shows another exemplary pictorially displayed result 100, which comprises an exemplary pictorial representation of the average reduction of b* (yellowness) from baseline for two tooth whitening products on a registration cell-by-cell basis within the HTROI 1712. A range of color-coded values 1705 (including, e.g., 1720-1726) associated with the reduction of b* (yellowness) from baseline of the registration cells are superimposed on a display image. According to the exemplary pictorial representation of FIG. 10, region 1732 has a greater reduction of b* than region 1730, for example. It should be understood that a variety of different colors, color combinations, and/or shading may be used in the pictorial displayed results.

Other comparisons may be made. The change in hard tissue property values may be with respect to a single subject, a group of subjects, for a single regimen or product, or a plurality of regimens, groups of products. Mathematical values may be derived from various property values, and may comprise any value or values derived from any operator, function, equation, algorithm, process or the like. Any mathematical values (including statistical values or any values derived from any algorithm) generated or calculated by comparing or manipulating color values from a plurality of images, plurality of subjects, plurality of regimens, or plurality of products is broadly referred to herein as comparison data. For instance, the change in the percent of dental enamel area covered in dental plaque between a first group of subjects and a second group of subjects can be made, wherein the first group may have used a first product or regimen and the second group may have used a second product or regimen. As another example, within-subject comparisons may be performed when subjects are imaged more than once. Within-subject comparisons may also be performed when subjects are imaged after using one or more products, regimens, or plurality of regimens. Averaging or any other mathematical calculation for the within-subject comparisons may be performed. When a plurality of subjects are involved (or even for a single subject), the mathematical difference (or other mathematical values such as a sum, a ratio, etc.) in the color values for the subjects can be statistically calculated (e.g., the differences for the plurality of subjects can be averaged or the variance, standard deviation, average deviation or mean absolute deviation, confidence interval, standard error, median, quartile, etc., can be calculated) to arrive at one or more representative statistically values that represents the plurality of subjects.

The average change in a hard tissue property value may also be displayed in tabular form 1510, as shown by way of example in FIG. 8. In the tabular example illustrated in FIG. 8, an objective digital plaque imaging analysis was utilized to assess plaque coverage. The method of this particular analysis involved plaque disclosure with a fluorescent dye followed by a digital image, using illumination of the anterior facial tooth surface. Images were then analyzed for total pixel area of teeth and plaque coverage. Various treatments were compared in the analysis. Within the exemplary table of FIG. 8, S indicates that p<0.05, and N indicates that the p-value was not statistically significant. Results may also be determined and displayed to compare the effects of different prophylaxis methods or regimens, different dental hygiene products or product combinations, demographic groups, or any combination of hygiene, products, prophylaxis, or demographic groups. Results may also be displayed as part of an advertising or marketing campaign to promote the effectiveness of a particular product or regimen.

Further, the average change in a hard tissue property value may be illustrated as a graph 1610, as shown by way of example in FIG. 9. The graph 1610 may be divided into different study periods 1615 in which different hygiene-related methods or products 1620 are used. For example, the study periods 1615 may be immediately after brushing in the morning, during the afternoon, and after an overnight sleep. The overall average percent plaque coverage on the tooth surface may be measured over a period of time 1630 using different products 1620.

In one exemplary embodiment, the present invention comprises a method for evaluating oral cavity hard tissue that includes the steps of identifying a hard tissue region of interest of a captured image, creating a plurality of registration cells within the hard tissue region of interest, associating at least one property value with at least one of the plurality of registration cells, the property value being determined from the captured image, analyzing the at least one property value of the at least one registration cell to form a hard tissue analysis result, and displaying the hard tissue analysis result pictorially onto a hard tissue image. The plurality of at least one first property values and the plurality of at least one second property values may be from a plurality of subjects. The step of analyzing the at least one property value may comprise calculating at least one mathematical value from at least one first property value and at least one second property value, wherein the first and second property values are associated with the at least one registration cell of the captured image.

The exemplary method set forth above may further comprise the step of recording a plurality of captured images. The method may also comprise the step of recording a plurality of captured images, wherein the plurality of captured images originating from a single subject. The method may also comprise recording a plurality of captured images that originate from a plurality of subjects. In addition, the plurality of subjects may be a part of one or more studies involving one or more oral care products.

Moreover, the captured image of the exemplary method may comprise a plurality of captured images of a plurality of subjects, and the method further may comprise a step of creating comparison data from the plurality of captured images. The captured image of the exemplary method may include a plurality of captured images of a plurality of subjects, and the method may further comprise creating comparison data from the plurality of captured images, wherein the plurality of captured images comprises images before a treatment and images after the treatment. Also, the captured image may include a plurality of captured images of a plurality of subjects, and the method may include creating comparison data from the plurality of captured images, wherein the plurality of captured images comprises images before a product use and images after the product use. The method may also comprises creating comparison data from the plurality of captured images of a plurality of subjects, wherein the captured images comprise images before a regimen and images after the regimen. In addition, the method may further comprise creating comparison data from the plurality of captured images of the plurality of subjects associated with one oral care product, wherein the captured images include images after a first regimen and images after a second regimen.

In one exemplary embodiment, the step of analyzing the at least one property value may include measuring the efficacy of at least one of a product, regimen, technique, or demographic on dental enamel health of at least one subject. The step of measuring the efficacy of at least one of a product, regimen, technique, or demographic on dental enamel health may comprise comparing a plurality of captured images from a first subject with a plurality of captured images from a second subject. Alternatively, the step of measuring the efficacy of at least one of a product, regimen, technique, or demographic on dental enamel health may include comparing a plurality of captured images from a subject, the plurality of captured images from the subject taken over a period of time.

In yet another exemplary embodiment, the step of analyzing the at least one property value may comprise statistically comparing the at least one registration cell of a first captured image with the at least one registration cell of a plurality of second captured images, wherein the plurality of second captured images is later in time than the first captured image. Alternatively, the step of analyzing the at least one property value may also comprise statistically analyzing a plurality of captured images over time using statistical data analysis methods.

In another exemplary embodiment, the present invention comprises a method for evaluating oral cavity hard tissue, including recording a plurality of captured images, identifying a hard tissue region of interest within each of the plurality of captured images, creating a plurality of registration cells within each hard tissue region of interest, associating a plurality of property values with at least one of the registration cells, calculating a mathematical value from the plurality of property values, wherein the plurality of property values are associated with the at least one registration cell of each captured image, creating comparison data from the mathematical value of each captured image to form a hard tissue analysis result, displaying the hard tissue analysis result pictorially on a hard tissue image.

In another exemplary embodiment of the present invention, a computer-readable medium may comprise computer-executable instructions for evaluating hard tissue comprising a computer-executable instructions for capturing an captured image, computer-executable instructions for identifying a hard tissue region of interest within the captured image, computer-executable instructions for creating a plurality of registration cells, the plurality of registration cells within the hard tissue region of interest, wherein at least one of the registration cells includes at least one pixel, the at least one pixel including at least one property value, computer-executable instructions for deriving statistics from the at least one property value, and computer-executable instructions for measuring the efficacy of at least one of a product, regimen, technique, or demographic on dental enamel health.

In another exemplary embodiment of the present invention, a system for evaluating hard tissue may comprise a controller coupled to a data store, the controller including an associated memory and a control program for directing operation of the controller, a camera coupled to the controller, the camera operable to capture a captured image, the captured image including at least one pixel, the at least one pixel including at least one property value, wherein the controller is operable to save the captured image to the data store, and wherein the controller is further operable to analyze and pictorially display the at least one property value.

In yet another exemplary embodiment of the present invention, a method for generating advertising indicia for a product may comprise identifying a hard tissue region of interest of a captured image, creating a plurality of registration cells, the plurality of registration cells within the hard tissue region of interest and including at least one pixel, the at least one pixel including at least one property value associated therewith, analyzing the at least one property value, displaying the at least one property value pictorially on the captured image, indicating a state of hard tissue health based on the at least one property value displayed pictorially on the captured image, and associating the state of hard tissue health with the product.

In yet another exemplary embodiment of the present invention, a self-contained kiosk for analyzing hard tissues, the kiosk may comprises a photosensitive detector, captured image data, the captured image data captured by the photosensitive detector, a computing device operable to identify a hard tissue region of interest of the captured image data, create a plurality of registration cells associated with the hard tissue region of interest, the plurality of registration cells within the hard tissue region of interest and including at least one pixel, the at least one pixel including at least one property value associated therewith, and analyze the at least one property value, a hard tissue analysis result, and a display device for displaying the hard tissue analysis result. The kiosk may further comprise customer identification data and a customer identification data input device, wherein the captured image data is associated with the customer identification data. Also, the kiosk may be located in a commercial establishment.

In still yet another exemplary embodiment, the present invention comprises a product package having an indicia related to product performance, the product performance being determined by: identifying a hard tissue region of interest of a captured image; creating a plurality of registration cells associated with the hard tissue region of interest, the plurality of registration cells within the hard tissue region of interest and including at least one pixel, the at least one pixel including at least one property value associated therewith; analyzing the at least one property value to assess the performance of the product; and printing an indicia on a product package, wherein the indicia is associated with the assessed performance of the product. The indicia on the product package may be an advertising claim.

The methods described above may be performed in a variety of settings for a variety of purposes. For example, the system may be part of and the methods may be performed as part of a point of sale kiosk where a customer may try a dentifrice or other hygiene product for a period of time in order to determine its effectiveness. For example, a kiosk located at a commercial establishment may contain a system for capturing an image of the customer's hard tissues, as well as accepting customer identification data, such as a personal identification number (e.g., social security number, etc.), a phone number, or address. A commercial establishment may be a store, a dentist office, clinic, trade show booth or any other like location. The system may then analyze the image using any one or a combination of the methods as previously described. The system may then present the user with an analysis of his hard tissues, display the hard tissue analysis results as shown and described herein, and include specific suggestions for suitable products and/or regimens to remedy any observed malady. For example, after analyzing the customer's dental enamel the kiosk may recommend a specific dental floss, dentifrice, powered or manual brush, rinse, adhesive, emollient or technique, or combinations thereof, to remedy the problem or potential problem. After trying the method or product for a period of time, the customer may return to the kiosk and enter his or her customer identification data for another dental enamel analysis. The system may then compare the results of the latest analysis with the previous analysis to determine the effectiveness of the product, technique, or regimen the customer used, including displaying the analysis results and the comparison results (e.g., pictorial displayed results) as shown and described herein. A similar method may be employed to allow the customer to compare and display the effectiveness of competing products. The kiosk may also compare the individual customer's data with a repository of other customer data to provide further comparative information. The kiosks or any system as previously described to capture and analyze captured hard tissue images may be distributed to allow the customer, a trained professional, or a technician to perform an analysis, display the results, or perform a comparison at many convenient locations. In addition to using the system and method in a point-of-sale setting, it may be used as part of a professional dental exam where the subject's hard tissue status may be determined as part of a periodic oral examination and comparisons are made between the condition or health of the hard tissue between dental visits. Further, the system may be employed as a mobile unit where technicians administer the test to subjects and provide an analysis without having to employ a trained professional to make an initial hard tissue assessment.

The results of many analyses may also be used as marketing or advertising information to promote the effectiveness of particular products, combinations of products, and techniques. Examples of advertising claims that could be placed on product packaging that might be substantiated by the present invention include, but are not limited to, establishment claims (e.g., “clinically proven” or “tests show”), before and after claims (e.g., “10% less dental plaque after use”), monadic claims, comparative claims, factor claims (e.g., “3× reduction in tooth surface stain”), and prevention and treatment claims. For example, product packages may refer to an analysis and demonstrate objectively-proven effectiveness, product performance or comparisons of the product. Also, analysis data may be used in clinical information related to different regimen that may or may not by used in combination with different products or groups of products.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims. Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims. It will be appreciated that any of the features, steps, or aspects of the present invention described herein may be combined, in whole or part, with any other feature, step, or aspect of the present invention described herein.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method for evaluating oral cavity hard tissue, comprising:
identifying a hard tissue region of interest of a captured image (415);
creating a plurality of registration cells (742) within the hard tissue region of interest (712);
associating at least one property value with at least one of the plurality of registration cells (742), the property value being determined from the captured image (415);
analyzing the at least one property value of the at least one registration cell (742) to form a hard tissue analysis result; and
displaying the hard tissue analysis result pictorially onto a hard tissue image (1300).

2. The method of claim 1 wherein the hard tissue analysis result is displayed pictorially on a display (116).

3. The method of claim 1, wherein the plurality of registration cells (742) are created by:
creating a plurality of vertical bands (725) across the hard tissue region of interest (712);
creating a plurality of horizontal bands (735) across the hard tissue region of interest (712); and
overlaying the plurality of vertical bands (725) and the plurality of horizontal bands (735) across the hard tissue region of interest.

4. The method of claim 1, wherein the plurality of vertical bands and the plurality of horizontal bands are generated by a computer program.

5. The method of claim 1, wherein the at least one registration cell (742) includes at least one pixel (500), the at least one pixel including the at least one property value.

6. The method of claim 1, wherein analyzing the at least one property value comprises averaging a plurality of the at least one property value for the at least one registration cell (742), thereby creating a cell value.

7. The method of claim 6 wherein the cell value is a percentage of plaque within the at least one registration cell (742).

8. The method of claim 6, wherein the cell value is an average of at least one of an L* value, an a* value, and a b* value.

9. The method of claim 1, wherein analyzing the at least one property value comprises:
calculating at least one mathematical value from at least one first property value and at least one second property value, wherein the first and second at least one property values are associated with the at least one registration cell (742) of the captured image;
associating a display color with the at least one mathematical value; and
displaying the display color on the hard tissue image (1300).

10. The method of claim 9, wherein the at least one mathematical value is a difference between the at least one first property value and the at least one second property value.

11. The method of claim 9, wherein the display color is displayed at a portion of the hard tissue image that corresponds with the at least one registration cell (742) of the captured image (415).

12. The method of claim 9, wherein the at least one first property value is associated with a first captured image and the at least one second property value is associated with a second captured image.

13. The method of claim 12, wherein the first and second captured images are from the same subject, and wherein the second captured image is created after the first captured image.

14. The method of claim 12, wherein the second captured image is created after the first captured image.

15. The method of claim 9, further comprising calculating a plurality of differences for a plurality of at least one first property values and a plurality of at least one second property values, wherein the plurality of differences are statistically manipulated to calculate a representative statistical value having a representative display color associated therewith.
